(19) United States
(12) Patent Application Publication
(10) Pub. No.: US 2024/0099316 A1
(43) Pub. Date: Mar. 28, 2024

(54) SOLID BAKING ADDITIVE

(71) Applicant: Novozymes A/S, Bagsvaerd (DK)

(72) Inventor: Erik Schmidt Marcussen, Ballerup (DK)

(73) Assignee: Novozymes A/S, Bagsvaerd (DK)

(21) Appl. No.: 17/766,588

(22) PCT Filed: Oct. 9, 2020
(86) PCT No.: PCT/EP2020/078401

§ 371 Date: Apr. 5, 2022

(30) Foreign Application Priority Data
Oct. 11, 2019 (EP) 19202729.0

(51) Int. Cl. A21D 8/04; A21D 10/00

(52) U.S. Cl. CPC A21D 8/047; A21D 8/042; A21D 10/005

(57) ABSTRACT

The invention provides a solid baking additive both baking enzymes and baker's yeast in a homogenous co-formulated form, which exhibit excellent enzyme stability.

### FIELD OF THE INVENTION

The present invention relates to a baking additive suitable for delivering baker's yeast and baking enzymes simultaneously to a baking process.

### BACKGROUND

Enzymes have been used in the baking industry for many years. They have typically been supplied as powdered/granulated products, intended to be added in the baking process together with flour and other ingredients (such as yeast)—for example as a baking premix or as an improver. In baking, improvers are widely used for different properties such as dough or batter tolerance, or baked product volume and/or freshness. Usually, these improver formulations are manufactured as a powder composition, which has to be pre-dosed (manually or automatically) by weighing and consequently added during the dough mixing process.

The need for convenience and product safety is growing strongly throughout the baked goods chain. Reducing complexity by simplification of baking processes and product formats is key to reduce time loss and spills. Nowadays, granulated enzyme products are commonly used in industrial baking processes, usually as part of a powdered improver, and can be implemented in the baking process by using (semi-)automated dosage equipment. However, in semi-industrial and artisan bakeries the degree of automation is lower, and a desire exists for a more convenient and flexible enzyme or improver delivery system, preferably without pre-dosing or pre-treatment step before addition to the mixers.

Moreover, (inter)national regulators are putting focus on the health & safety risks (rhinitis) of airborne dust from bakery ingredients, throughout the entire bakery chain, mostly related to the presence of fungal amylases present in flour and concentrated bakery ingredients (improvers). In general, reducing flour and enzyme dust exposure in bakeries will reduce the likelihood of work related respiratory symptoms. Flour and enzyme handling activities that may generate dust should be prevented to minimize the risk of exposures.

For above mentioned reasons, there is still a need for a product format that combines the aspects of convenience, flexibility, reliability and safety to be used as baking improver. Generating pre-dosed solid items containing functional bakery ingredients reduces pre-weighing processes of powder improvers (before addition to mixers), and as such dust formation and spills of concentrated bakery ingredients significantly. This invention relates to the production and application of a co-formulated enzyme and yeast.

### SUMMARY OF THE INVENTION

The present invention provides, in a first aspect, a solid baking additive, comprising
(a) 0.01 to 20% w/w of active enzyme protein, and
(b) at least 25% w/w of baker's yeast.

In embodiments, the baking additive further comprises emulsifiers, and/or ascorbic acid.

In other embodiments, the baking additive further comprises a total water content of less than 75% w/w. The total water content is the sum of the yeast intracellular water, and the free (extracellular) water in the composition.

The invention also relates to a dough and baked product prepared by using the baking additive of the invention.

The additive is substantially free of enzyme dust, homogenous and exhibits excellent enzyme stability.

Other aspects and embodiments of the invention are apparent from the description and examples.

Unless otherwise indicated, or if it is apparent from the context that something else is meant, all percentages are percentage by weight (% w/w).

Unless otherwise indicated, all particle sizes are the volume based particle diameter, and the average particle size is the volume average particle diameter (which is the same as the weight based particle diameter, if the densities of the particles are the same). Particle size may be measured using laser diffraction methods or optical digital imaging methods or sieve analysis.

### DETAILED DESCRIPTION

We have found that it is possible to make a solid co-formulation of baker's yeast and baking enzymes, where the physical and biological stability of both yeast and enzymes is not compromised.

There are several advantages of delivering the yeast and enzymes in a co-formulation. When enzymes are delivered together with the yeast, the water content will ensure that free enzyme dust will not be formed, and the enzyme is generally encapsulated in the yeast matrix. Further, the co-formulation will act as a unit-dose product, simultaneously providing the necessary amount of both yeast and enzymes in one convenient product.

Yeast cells in commercial baker's yeast products are not exposed to any significant amount of extracellular enzymes, and accordingly, the biological stability of the yeast could very well be affected by the presence of commercial baking enzymes in a co-formulation.

Likewise, enzymes in solid baking additives are not exposed to a humid/wet environment with living yeast cells. A wet environment is normally detrimental to enzyme stability, unless stabilizing agents are added, as in liquid enzyme products. Like many microbial cells, yeast cells may also secrete proteases that is capable of degrading the protein structure of enzymes.

Thus, there are many reasons to believe that it would not be possible to make a storage stable co-formulation of enzymes and yeast; however, we have successfully made such formulations that retain both enzymatic activity and yeast viability.

### Baking Additive

The baking additive of the invention is a solid composition comprising
(a) 0.01 to 20% w/w of active enzyme protein, and
(b) at least 25% w/w of baker's yeast;
wherein the baking additive is a homogenous mixture of yeast cells and enzyme protein, and wherein yeast cells and enzyme protein are in direct contact.

The baking additive is a co-formulation, where yeast forms a continuous matrix encapsulating the enzyme. The enzyme is present in the yeast matrix as solubilized enzyme; or if the baking additive is dried, the enzyme is distributed in the yeast matrix as individual enzyme proteins. The enzyme is not granulated or otherwise on a particulate form.

The baking additive is prepared by mixing a solid composition comprising the baker's yeast with a liquid enzyme composition, which may subsequently be dried (for example in a fluid bed or air dryer) to reduce the water content.

The baking additive is a solid composition, which may be soft or hard, but not a liquid.

When the water content is below 10% w/w, the baking additive is typically a solid dried yeast/enzyme matrix, which has a small average particle size. Small dried yeast particles are well-known and widely used by consumers all over the world as “active dry yeast” and “instant yeast”.

The small enzyme/yeast particles of the invention may be produced by extruding the enzyme/yeast mixture, followed by drying. Such extruded particles may be cylindrical with a longest dimension (length) of 1-5 mm. The cylinder diameter is determined by the size of the extruder die, which is typically 0.1-0.6 mm, preferably 0.2-0.5 mm.

A small particle size is desirable in order to increase the rate of rehydration/wetting of the baking additive in a baking process. Baking additives with a low water content generally exhibit improved storage stability compared to additives with a higher water content. A baking additive in the form of a plurality of particles, as described above, typically has excellent flowability and exhibits free-flowing behavior.

When the water content is above 10% w/w (and up to 75% w/w, when both yeast intracellular and extracellular water is included) the baking additive is typically a solid, but soft, product (such as a “crumbled”, “compressed”, “pressed”, or “cake”) yeast/enzyme composition. This is a well-known form of yeast products used in the baking industry, but it is also sold as an end-consumer product.

As mentioned above, the baking additive forms less free enzyme dust during handling, as compared to solid enzyme particles comprising the same amount of enzyme and no yeast.

The enzymes of the baking additive are described below. The enzyme content of the baking additive may be 0.01 to 20% w/w of active enzyme protein. In an embodiment, the enzyme content is 0.05 to 15% w/w of active enzyme protein, preferably 0.1 to 15% w/w of active enzyme protein, more preferably 0.1 to 10% w/w of active enzyme protein, and most preferably 0.5 to 10% w/w of active enzyme protein.

Baker's yeast is the common name for the strains of yeast commonly used in baking bread and bakery products, serving as a leavening agent which causes the bread to rise (expand and become lighter and softer) by converting the fermentable sugars present in the dough into carbon dioxide and ethanol. Baker's yeast is of the species Saccharomyces cerevisiae. The baker's yeast of the baking additive may be any commercial strain of Saccharomyces cerevisiae. The baker's yeast may be included in the baking additive in a total amount of at least 25% w/w, preferably 25-95% w/w, more preferably 40-95% w/w, and most preferably 50-95% w/w.

The baking additive may further include ascorbic acid, emulsifiers, and/or other baking ingredients. The amount of ascorbic acid in the baking additive may be less than 10% w/w or 0.1-10% w/w, such as less than 5% w/w or 0.1-5% w/w. Emulsifiers are described below and may be added in amount of less than 10% w/w or 0.1-10% w/w, such as less than 5% w/w or 0.1-5% w/w.

### Enzymes

The enzymes used in the baking additive of the invention are catalytic proteins, and the term “active enzyme protein” is defined herein as the amount of catalytic protein(s), which exhibits enzymatic activity. This can be determined using an activity based analytical enzyme assay. In such assays, the enzyme typically catalyzes a reaction generating a colored compound. The amount of the colored compound can be measured and correlated to the concentration of the active enzyme protein. This technique is well-known in the art. The active enzyme protein may be fungal or bacterial enzyme(s).

The enzyme(s) used in the preparation of, and as a component of, the baking additive is(are) any enzyme suitable for use in baking. In particular the enzyme(s) is(are) selected from the group consisting of aminopeptidase, amylase, alpha-amylase, maltogenic alpha-amylase, beta-amylase, lipolytic enzymes, carboxypeptidase, catalase, chitinase, cutinase, cyclodextrin glycosyltransferase, deoxyribonuclease, esterase, galactanase, glucan 1,4-alpha-maltotetrahydrolase, glucanase, alpha-galactosidase, beta-galactosidase, glucoamylase, alpha-glucosidase, beta-glucosidase, hemicellulase, haloperoxidase, invertase, laccase, mannanase, mannosidase, oxidase, pectinolytic enzymes, peptidoglutaminase, peroxidase, phospholipase, phytase, polyphenoloxidase, proteolytic enzyme, ribonuclease, transglutaminase, xylanase, and mixtures thereof.

The amylase may be fungal or bacterial; e.g., a maltogenic alpha-amylase (EC 3.2.1.133) from Bacillus stearothermophilus; an alpha-amylase (EC 3.2.1.1) from Bacillus, e.g. B. licheniformis or B. amyloliquefaciens; a beta-amylase (EC 3.2.1.2), e.g., from plant (e.g. soy bean) or from microbial sources (e.g., Bacillus); a fungal alpha-amylase, e.g., from A. oryzae or A. niger, a glucoamylase/amyloglucosidase (EC 3.2.1.3) from, e.g., an Aspergillus species; or an anti-staling amylase (maltotetraose-forming amylase; glucan 1,4-alpha-maltotetrahydrolase; EC 3.2.1.60) from, e.g., a Pseudomonas species.

The glucoamylase may have a sequence identity of at least 50%, at least 60%, at least 65%, at least 70%, at least 75%, at least 80%, at least 85%, at least 90%, at least 95%, at least 96%, at least 97%, at least 98%, or at least 99% to the amino acid sequence of the Aspergillus niger G1 or G2 glucoamylase (Boel et al. (1984), EMBO J. 3 (5), p. 1097-1102), the A. awamori glucoamylase disclosed in WO 84/02921, or the A. oryzae glucoamylase (Agric. Biol. Chem. (1991), 55 (4), p. 941-949).

The maltogenic alpha-amylase may also be a maltogenic alpha-amylase as disclosed in, e.g., WO1999/043794; WO2006/032281; or WO2008/148845.

Suitable commercial maltogenic alpha-amylases include NOVAMYL, OPTICAKE 50 BG, and OPTICAKE 3D (available from Novozymes A/S). Suitable commercial fungal alpha-amylase compositions include BAKEZYME P 300 (available from DSM) and FUNGAMYL 2500 SG, FUNGAMYL 4000 BG, FUNGAMYL 800 L, FUNGAMYL ULTRA BG and FUNGAMYL ULTRA SG (available from Novozymes A/S).

The anti-staling amylase may also be an amylase as disclosed in, e.g., WO1999/050399, WO2004/111217, or WO2005/003339.

The glucose oxidase may be a fungal glucose oxidase, in particular an Aspergillus niger glucose oxidase (such as GLUZYME®, available from Novozymes A/S).

The lipolytic enzyme is an enzyme (EC 3.1.1) having lipase, phospholipase and/or galactolipase activity; especially an enzyme having lipase and phospholipase activity.

The lipase exhibit triacylglycerol lipase activity (EC 3.1.1.3), i.e., hydrolytic activity for carboxylic ester bonds in triglycerides, e.g., tributyrin.

The phospholipase exhibit phospholipase activity (A1 or A2, EC 3.1.1.32 or 3.1.1.4), i.e., hydrolytic activity towards one or both carboxylic ester bonds in phospholipids such as lecithin.

The galactolipase exhibit galactolipase activity (EC 3.1.1.26), i.e., hydrolytic activity on carboxylic ester bonds in galactolipids such as DGDG (digalactosyl diglyceride).

The hemicellulase may be a pentosanase, e.g., a xylanase which may be of microbial origin, e.g., derived from a bacterium, such as a strain of Bacillus, in particular a strain of B. subtilis, or a strain a strain of Pseudoalteromonas, in particular P. haloplanktis, or derived from a fungus, such as a strain of Aspergillus, in particular of A. aculeatus, A. niger, A. awamori, or A. tubigensis, from a strain of Trichoderma, e.g., T. reesei, or from a strain of Humicola, e.g., H. insolens.

Suitable commercially available xylanase preparations for use in the present invention include PANZEA BG, PENTOPAN MONO BG and PENTOPAN 500 BG (available from Novozymes A/S), GRINDAMYL POWERBAKE (available from DuPont), and BAKEZYME BXP 5000 and BAKEZYME BXP 5001 (available from DSM).

The protease may be from Bacillus, e.g., B. amyloliquefaciens or from Thermus aquaticus.

The enzyme(s) used to prepare the baking additive of the invention may be mixed with the baker's yeast in the form of enzyme particles or liquid enzyme formulations. Enzyme particles are well-known in the art and may, for example, be spray dried enzyme particles, layered enzyme particles, or granulated enzyme particles. Likewise, liquid enzyme formulations are well-known in the art and may, for example, be aqueous solutions optionally comprising stabilizing agents, such as polyols, sugars, and/or salts.

### Dough

In one aspect, the invention discloses a method for preparing dough, or a baked product prepared from the dough, which method comprises incorporating into the dough the baking additive of the invention.

The present invention also relates to methods for preparing a dough or a baked product comprising incorporating into the dough an effective amount of the baking additive of the invention which improves one or more properties of the dough or the baked product obtained from the dough, when compared to a dough or a baked product in which the baking additive is not incorporated.

The phrase “incorporating into the dough” is defined herein as adding the baking additive of the invention to the dough, to any ingredient from which the dough is to be made, and/or to any mixture of dough ingredients from which the dough is to be made. In other words, the baking additive of the invention may be added in any step of the dough preparation and may be added in one, two or more steps. The baking additive is added to the ingredients of dough that may be kneaded or mixed and baked to make the baked product using methods well known in the art.

The term “effective amount” is defined herein as an amount of the baking additive of the invention that is sufficient for providing a measurable effect on at least one property of interest of the dough and/or baked product.

Non-limiting examples of properties of interest are dough tolerance, rheology (stickiness, elasticity, extensibility) and machinability, baked product volume, softness, resilience, cohesiveness, elasticity, crust colour, sliceability, short bite.

The term “dough” is defined herein as a mixture of flour and other ingredients firm enough to knead or roll. In the context of the present invention, batters are encompassed in the term “dough”.

The dough of the method of the invention may comprise flour derived from any cereal grain or other sources, including wheat, emmer, spelt, einkorn, barley, rye, oat, corn, sorghum, rice, millet, amaranth, quinoa, and cassava.

The dough may also comprise other conventional dough ingredients, e.g., proteins, such as milk powder, gluten, and soy; eggs (either whole eggs, egg yolks, or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate, or calcium sulfate, gum(s), fibre(s), preservatives, and/or an emulsifier.

The dough may comprise one or more lipid material (such as e.g. margarine, butter, oil, shortening), eventually in granular form.

The dough may be gluten-free dough.

The dough of the method of the invention may be fresh, frozen or par-baked (pre-baked).

The dough of the method of the invention is a non-leavened dough, a leavened dough or a dough to be subjected to leavening.

### Emulsifiers

For some applications, an emulsifier is not needed; for some applications an emulsifier may be needed.

A suitable emulsifier is preferably an emulsifier selected from the group consisting of diacetyl tartaric acid esters of monoglycerides (DATEM), sodium stearoyl lactylate (SSL), calcium stearoyl lactylate (CSL), ethoxylated mono- and diglycerides (EMG), distilled monoglycerides (DMG), polysorbates (PS), succinylated monoglycerides (SMG), propylene glycol monoester, sorbitan emulsifiers, polyglycerol esters, sucrose esters and lecithin.

In some applications, a lipolytic enzyme may replace part, or even all, of the emulsifier(s) usually present in the dough recipe.

### Baked Product

The process of the invention may be used for any kind of baked product prepared from dough, particular of a soft character, either of a white, light or dark type. Non-limiting examples are bread (in particular white, whole-meal or rye bread), typically in the form of loaves or rolls, soft rolls, bagels, donuts, Danish pastry, puff pastry, laminated baked products, steamed buns, hamburger rolls, pizza, pita bread, ciabatta, sponge cakes, cream cakes, pound cakes, muffins, cupcakes, steamed cakes, waffles, brownies, cake donuts, yeast raised donuts, baguettes, rolls, crackers, biscuits, cookies, pie crusts, rusks and other baked products.

Further embodiments of the invention include:

Embodiment 1. A solid baking additive, comprising
(a) 0.01 to 20% w/w of active enzyme protein, and
(b) at least 25% w/w of baker's yeast;
wherein the baking additive is a homogenous mixture of yeast cells and enzyme protein, and wherein yeast cells and enzyme protein are in direct contact.

Embodiment 2. The baking additive of embodiment 1, which further comprises an emulsifier.

Embodiment 3. The baking additive of embodiment 1, which further comprises less than 10% w/w of an emulsifier.

Embodiment 4. The baking additive of embodiment 1, which further comprises 0.1-10% w/w of an emulsifier.

Embodiment 5. The baking additive of embodiment 1, which further comprises less than 5% w/w of an emulsifier.

Embodiment 6. The baking additive of embodiment 1, which further comprises 0.1-5% w/w of an emulsifier.

Embodiment 7. The baking additive of any of embodiments 1-6, which further comprises ascorbic acid.

Embodiment 8. The baking additive of any of embodiments 1-7, which further comprises less than 10% w/w of ascorbic acid.

Embodiment 9. The baking additive of any of embodiments 1-8, which further comprises 0.1-10% w/w of ascorbic acid.

Embodiment 10. The baking additive of any of embodiments 1-9, which further comprises less than 5% w/w of ascorbic acid.

Embodiment 11. The baking additive of any of embodiments 1-10, which further comprises 0.1-5% w/w of ascorbic acid.

Embodiment 12. The baking additive of any of embodiments 1-11, wherein the enzyme is extracellular to the yeast.

Embodiment 13. The baking additive of any of embodiments 1-12, wherein the enzyme is selected from the group consisting of amylase, oxidase, lipolytic enzyme, hemicellulase, and combinations thereof.

Embodiment 14. The baking additive of any of embodiments 1-13, wherein the enzyme is an amylase.

Embodiment 15. The baking additive of any of embodiments 1-13, wherein the enzyme is an oxidase.

Embodiment 16. The baking additive of any of embodiments 1-13, wherein the enzyme is a lipolytic enzyme.

Embodiment 17. The baking additive of any of embodiments 1-13, wherein the enzyme is a xylanase.

Embodiment 18. The baking additive of any of embodiments 13-17, wherein the amylase is selected from the group consisting of alpha-amylase (EC 3.2.1.1), beta-amylase (EC 3.2.1.2), glucoamylase (EC 3.2.1.3), maltogenic amylase (EC 3.2.1.133), and maltotetraose-forming amylase (EC 3.2.1.60).

Embodiment 19. The baking additive of any of embodiments 13-18, wherein the oxidase is selected from the group consisting of glucose oxidase (EC 1.1.3.4) and hexose oxidase (EC 1.1.3.5).

Embodiment 20. The baking additive of any of embodiments 13-19, wherein the lipolytic enzyme is selected from the group consisting of lipase (EC 3.1.1.3), phospholipase (EC 3.1.1.4 or EC 3.1.1.32), and galactolipase (EC 3.1.1.26).

Embodiment 21. The baking additive of any of embodiments 13-20, wherein the hemicellulase is a pentosanase.

Embodiment 22. The baking additive of any of embodiments 13-21, wherein the hemicellulase is a xylanase (EC 3.2.1.8 or EC 3.2.1.32).

Embodiment 23. The baking additive of any of embodiments 1-22, which comprises 0.05 to 20% w/w of active enzyme protein.

Embodiment 24. The baking additive of any of embodiments 1-23, which comprises 0.1 to 20% w/w of active enzyme protein.

Embodiment 25. The baking additive of any of embodiments 1-24, which comprises 0.1 to 15% w/w of active enzyme protein.

Embodiment 26. The baking additive of any of embodiments 1-25, which comprises 0.5 to 15% w/w of active enzyme protein.

Embodiment 27. The baking additive of any of embodiments 1-26, which comprises 0.5 to 10% w/w of active enzyme protein.

Embodiment 28. The baking additive of any of embodiments 1-27, which comprises 25-95% w/w of baker's yeast.

Embodiment 29. The baking additive of any of embodiments 1-28, which comprises 40-95% w/w of baker's yeast.

Embodiment 30. The baking additive of any of embodiments 1-29, which comprises 50-95% w/w of baker's yeast.

Embodiment 31. The baking additive of any of embodiments 1-30, which further comprises less than 75% w/w of total water.

Embodiment 32. The baking additive of any of embodiments 1-31, which further comprises less than 10% w/w of total water.

Embodiment 33. The baking additive of any of embodiments 1-32, which is an enzymatic “dry yeast” particle for baking.

Embodiment 34. The baking additive of any of embodiments 1-32, which is an enzymatic “active dry yeast” particle for baking.

Embodiment 35. The baking additive of any of embodiments 1-32, which is an enzymatic “instant yeast” particle for baking.

Embodiment 36. The baking additive of any of embodiments 1-35, which is an extrudate.

Embodiment 37. The baking additive of any of embodiments 1-36, wherein the enzyme is evenly distributed in a mixture with the yeast.

Embodiment 38. A method for preparing the solid baking additive of any of embodiments 1-37, comprising mixing
(a) a solid composition comprising the baker's yeast, and
(b) a liquid composition comprising the enzyme protein;
and optionally drying the mixture.

Embodiment 40. A method for preparing a dough, comprising mixing water, flour, and the solid baking additive of any of embodiments 1-39.

Embodiment 41. A dough prepared according to embodiment 40.

Embodiment 42. A method for preparing a baked product, comprising baking the dough of embodiment 41.

The present invention is further described by the following examples which should not be construed as limiting the scope of the invention.

### EXAMPLES

Chemicals were commercial products of at least reagent grade.
An emulsifier crème was prepared from the following ingredients:
200 g of water, approximately. 70° C.;
20 g Delamex 160; and
8 g acacia gum.
   Water and Delamex 160 were mixed and stirred intensively using an Ultra Turrax to form a homogeneous crème. Then the acacia gum was added followed by stirring to homogenize. The final emulsifier crème was stored cold in a refrigerator.

### Example 1

Amylase Co-Granulate with Yeast and Emulsifier and Ascorbic Acid

### Ingredients:

600 g fresh pressed yeast (crumble yeast, consumer product from Danish Supermarket) with approximately 33% dry matter;
31 g emulsifier crème (see above);
2.1 g Fungamyl concentrate (Novozymes), app. 33% Dry Matter; and
3 g ascorbic acid.

The ingredients were blended in a Hobart kitchen mixer for 1.5 minutes to obtain a homogeneous mixture.

The mixture was then pressed to increase the dry matter and reach an extrudable paste. Then the paste was extruded using a Lab Fuji Paudal extruder with dome shaped 0.5 mm die. With optimal dry matter the extrudate easily breaks up into small particles. The particles were transferred to a Strea fluid bed and fluidized and dried using hot air with an inlet air temperature of 60° C. When the product temperature started to increase above 30° C., the inlet air temperature was decreased to 40-45° C., and the particles were dried to reach a Dry Matter above 90%.

The final product was a homogeneous co-form of amylase enzyme, dry yeast, emulsifier and ascorbic acid. The enzyme activity was found to be 15 FAU(F)/g using a Fungamyl assay available from Novozymes.

1. A solid baking additive, comprising:
(a) 0.01 to 20% w/w of active enzyme protein, and
(b) at least 25% w/w of baker's yeast;
wherein the baking additive is a homogenous mixture of the baker's yeast cells and enzyme protein, and
wherein the baker's yeast cells and enzyme protein are in direct contact.

2. The baking additive of claim 1, which further comprises an emulsifier.

3. The baking additive of claim 1, which further comprises ascorbic acid.

4. The baking additive of claim 1, wherein the enzyme is selected from the group consisting of amylase, oxidase, lipolytic enzyme, and hemicellulase.

5. The baking additive of claim 1, wherein the enzyme protein is extracellular to the yeast.

6. The baking additive of claim 1, which comprises less than 75% w/w of total water.

7. The baking additive of claim 1, which comprises less than 10% w/w of total water.

8. The baking additive of claim 1, which is a cylindrical particulate with a longest dimension of 1-5 mm.

9. A method for preparing the solid baking additive of claim 1, comprising mixing
(a) a solid composition comprising the baker's yeast, and
(b) a liquid composition comprising the enzyme protein.

10. A dough premix, comprising flour, and the solid baking additive of claim 1.

11. A method for preparing a dough, comprising mixing water, flour, and the solid baking additive of claim 1.

12. The method of claim 9, further comprising drying the mixture.
